(19) United States
(12) Patent Application Publication
(10) Pub. No.: US 2015/0139559 A1
(43) Pub. Date: May 21, 2015

(54) SYSTEM AND METHOD FOR SHAPE CLUSTERING USING HIERARCHICAL CHARACTER CLASSIFIERS

(71) Applicant: Raymond Wensley Smith, Los Altos, CA (US)

(72) Inventor: Raymond Wensley Smith, Los Altos, CA (US)

(73) Assignee: GOOGLE INC., Mountain View, CA (US)

(21) Appl. No.: 13/617,306

(22) Filed: Sep. 14, 2012

(51) Int. Cl. G06K 9/18; G06K 9/00; G06K 9/62; G06K 9/72

(52) U.S. Cl. CPC G06K 9/00456; G06K 9/6215; G06K 9/72; G06K 9/6219; G06K 9/628
USPC 382/225; 382/182

(57) ABSTRACT

A system and method of processing an image of a document using an optical character recognition process is disclosed. In one example, the method comprises acts of extracting, by a computer system, a plurality of recognizable units from the document, extracting, by the computer system, a plurality of features from the plurality of recognizable units, separating, by the computer system, the plurality of recognizable units, based on the plurality of extracted features into a plurality of fragments having at least one fragment type, determining a distance metric between the plurality of recognizable units, based on the plurality of extracted features, and classifying, by the computer system, the plurality of recognizable units into a plurality of clusters based on the distance metric, each cluster including a set of recognizable units associated with a shape classification.

### BACKGROUND

Optical character recognition (OCR) uses computer software (or an OCR engine), to process digital images of printed, typewritten, handwritten, or other written text, whether originally on paper, microfilm, or other medium, and to produce machine recognizable and editable text from the images. The digital image of a document processed by the OCR engine may include images of multiple pages of written material. The images of the text to be processed by the OCR engine may be obtained by various imaging methods including using an image scanner to capture digital images of the text. The OCR engine analyzes the scanned image and produces an output document which includes the imaged document converted into standard character text.

### SUMMARY

To improve character detection accuracy, the OCR engine may analyze the OCR document in two stages. In the first stage, the OCR engine processes the images document to produce a first OCR output document. At the same time the OCR training engine analyzes one or more training sample documents to generate training data comprising shape classifications. At the second stage, the training shape classifications are applied to the first OCR output document to correct any erroneously recognized characters.

The OCR training engine may make errors during the processing resulting in poor overall accuracy of detection. For example, OCR accuracy for complex scripts for such languages as Traditional Chinese, Japanese, Telugu, Kannada, Malayalam, and Thai, is very low, where the number of symbols to be distinguished is very high. In addition, there may be a number of inherently similar character shapes. In analyzing complex scripts, the OCR training engine may assign an incorrect shape classification to a bounding box due to the image similarity between the shape enclosed by the bounding box and a reference character for a different character code.

Therefore, aspects and embodiments are directed to a system and method that improves shape classification detection and reduce the number of erroneous character detections. According to one embodiment, the system and method that includes an OCR training engine which combines a number of methods of improved detection and classification of characters and character fragments. Various methods and systems described herein result in a number of benefits, including higher character detection accuracy.

According to one embodiment, a computer-implemented method of processing an image of a document using an optical character recognition process is disclosed. In one example the method comprises extracting, by a computer system, a plurality of recognizable units from the document, extracting, by the computer system, a plurality of features from the plurality of recognizable units, separating, by the computer system, the plurality of recognizable units, based on the plurality of extracted features into a plurality of fragments having at least one fragment type, determining a distance metric between the plurality of recognizable units, based on the plurality of extracted features, and classifying, by the computer system, the plurality of recognizable units into a plurality of clusters based on the distance metric, each cluster including a set of recognizable units associated with a shape classification.

In one example, the at least one fragment type includes at least one of naturally fragmented recognizable units, chopped fragmented recognizable units, naturally touching recognizable units, and correctly segmented recognizable units. In addition, the plurality of recognizable units may include any of clip images, outline polygons, or character edges.

In another example, the method may further include an act of replacing the naturally fragmented recognizable units with individual recognizable units. In addition, the method may further include an act of comparing the naturally fragmented recognizable units and the correctly segmented recognizable units to the plurality of recognizable units included in a validation set of recognizable units.

In one example, the act of assigning the plurality of recognizable units the at least one hierarchical classifier further includes an act of dividing the plurality of recognizable units into a hierarchy of classes, wherein the recognizable units in each class are assigned a different classifier. In addition, the act of dividing the plurality of recognizable units into the hierarchy of classes may further include an act of determine at least one hierarchical class using a multi-class classifier. In another example, the act of dividing the plurality of recognizable units into the hierarchy of classes further determining at least one hierarchical class using runoff elections. The method may further include an act of merging pairs of recognizable units separated by a defined shape metric distance until the defined shape metric distance exceed a minimum threshold.

In another example, the method may further include an act of separating at least one of the naturally touching recognizable units and the chopped fragmented recognizable units.

According to another embodiment, a system of processing an image of a document using an optical character recognition process is disclosed. In one example, the system includes a non-transitory computer storage medium, and a processor coupled to the non-transitory computer storage medium, the processor configured to extract a plurality of recognizable units from the document, extract a plurality of features from the plurality of recognizable units, determine a distance metric between the plurality of recognizable units, classify the plurality of recognizable units into a plurality of clusters based on the distance metric, each cluster including a set of recognizable units associated with a shape classification, and store any of the plurality of recognizable units, the plurality of clusters, the distance metric and the shape classification.

In another example, the processor is further configured to separate the plurality of recognizable units, using the plurality of extracted features into a plurality of fragments including at least one of: naturally fragmented recognizable units, chopped fragmented recognizable units, naturally touching recognizable units, and correctly segmented recognizable units. In addition, the processor may be further configured to replace the naturally fragmented recognizable units with individual recognizable units and the cluster processing module is configured to analyze the plurality of recognizable units using hierarchical agglomerative clustering.

In one example, the processor is further configured to compare the naturally fragmented recognizable units and the correctly segmented recognizable units to the plurality of recognizable units included in a validation set of recognizable units. In addition, the processor may be further configured to divide the plurality of recognizable units into a hierarchy of classes, wherein recognizable units in each class are assigned a different classifier. In another example, the processor is further configured to determine at least one hierarchical class using a multi-class classifier. In yet another example, the processor is further configured to determine at least one hierarchical class using runoff elections.

In another example, the processor is further configured to separate at least one of the naturally touching recognizable units and the chopped fragmented recognizable units. In the system, the plurality of recognizable units may include any of clip images, outline polygons, or character edges.

According to another embodiment, a computer readable medium having stored thereon sequences of instruction for processing an image of a document using an optical character recognition process is disclosed. In one example, the instructions will cause a processor to extract a plurality of recognizable units from the document, extract a plurality of features from the plurality of recognizable units, determine a distance metric between the plurality of recognizable units, classify the plurality of recognizable units into a plurality of clusters based on the distance metric, each cluster including a set of recognizable units associated with a shape classification, and store any of the plurality of recognizable units, the plurality of clusters, the distance metric and the shape classification.

Still other aspects, embodiments, and advantages of these exemplary aspects and embodiments, are discussed in detail below. Any embodiment disclosed herein may be combined with any other embodiment in any manner consistent with at least one of the objects, aims, and needs disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described in connection with the embodiment may be included in at least one embodiment. The appearances of such terms herein are not necessarily all referring to the same embodiment. The accompanying drawings are included to provide illustration and a further understanding of the various aspects and embodiments, and are incorporated in and constitute a part of this specification. The drawings, together with the remainder of the specification, serve to explain principles and operations of the described and claimed aspects and embodiments.

### BRIEF DESCRIPTION OF THE DRAWINGS

Various aspects of at least one embodiment are discussed below with reference to the accompanying figures, which are not intended to be drawn to scale. Where technical features in the figures, detailed description or any claim are followed by references signs, the reference signs have been included for the sole purpose of increasing the intelligibility of the figures, detailed description, and claims. Accordingly, neither the reference signs nor their absence are intended to have any limiting effect on the scope of any claim elements. In the figures, each identical or nearly identical component that is illustrated in various figures is represented by a like numeral. For purposes of clarity, not every component may be labeled in every figure. The figures are provided for the purposes of illustration and explanation and are not intended as a definition of the limits of the invention. In the figures:

FIG. 1A is a block diagram of an example of an Optical Character Recognition (OCR) processing of an imaged document, according to one embodiment;

FIG. 1B is a block diagram of an example of the OCR training module, according to one embodiment;

FIG. 2 is a diagram of an example of an OCR processed document, according to one embodiment;

FIG. 3 is a flow diagram of a method of radical analysis, according to one embodiment;

FIG. 4 is a diagram of one example of extracted and classified fragments, according to one embodiment;

FIG. 5 is a flow diagram of a method of shape clustering using a hierarchical classifier, according to one embodiment;

FIG. 6 is a flow diagram of a method of determining a distance metric used in shape clustering, according to one embodiment;

FIG. 7A is a diagram of one example of extracted features from character shapes, according to one embodiment;

FIG. 7B is a diagram of one example of near neighbor features, according to one embodiment;

FIG. 8 is a diagram of one example of cloud samples determined from character features, according to one embodiment; and

FIG. 9 is a block diagram of one example of a computer system that may be used to perform processes and functions disclosed herein.

### DETAILED DESCRIPTION

As described above, previously used methods of character segmentation and detection of complex scripts may result in poor overall accuracy of detection. Accordingly, there is a need for a system and method of Optical Character Recognition (OCR) character processing that improves character detection and classification of complex scripts. According to one embodiment of the present invention, the system combines methods of shape clustering, radical analysis, hierarchical classification, feature selection and multi-class classifiers, which result in accurate detection of complex scripts and improve overall OCR accuracy.

As described herein, shape clustering is a method for gathering together like shapes into clusters. It is appreciated that shape clustering is typically applied in classification methods to partition character feature space into regions known as classes, such that shape classifications can then recognize shapes of each class. As described below, methods of shape clustering are improved by using a distance metric used to form the clusters. In addition embodiments described herein, shape clustering is used to perform radical analysis helps to improve accuracy of detection of complex scripts. Furthermore, shape clustering is further used in the embodiments described herein to determine a classifier hierarchy. While typical hierarchical classifiers are usually binary and homogeneous, the hierarchical classifiers described herein are non-binary and heterogeneous. The use of radical analysis and hierarchical classifiers also increases detection of naturally touching and chopped character fragments.

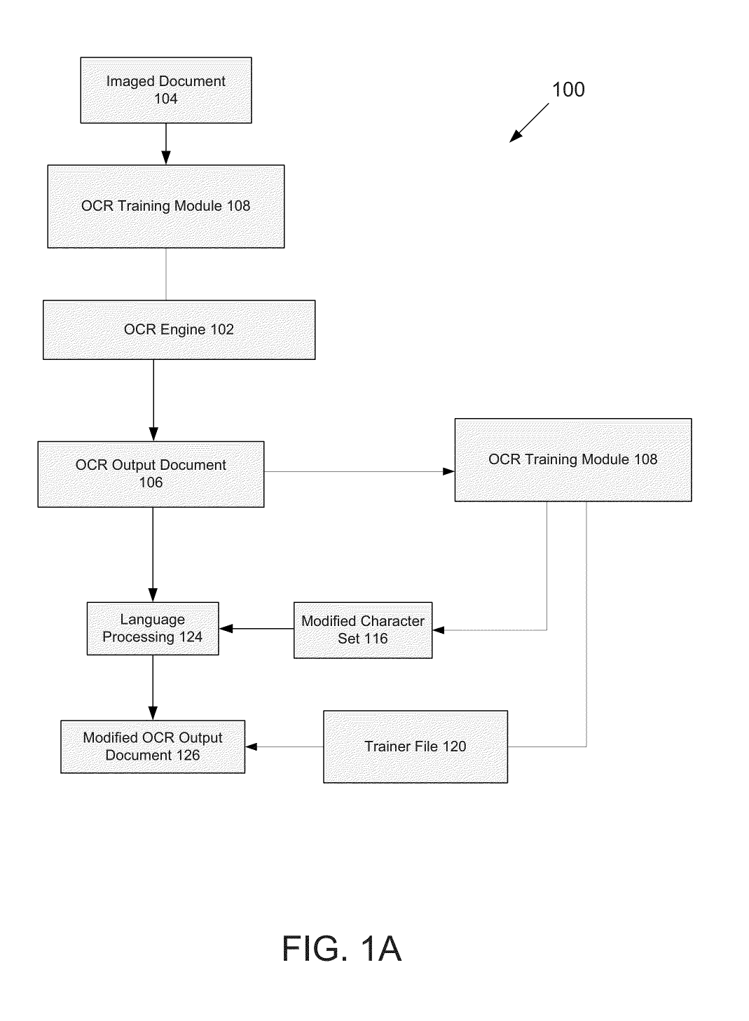

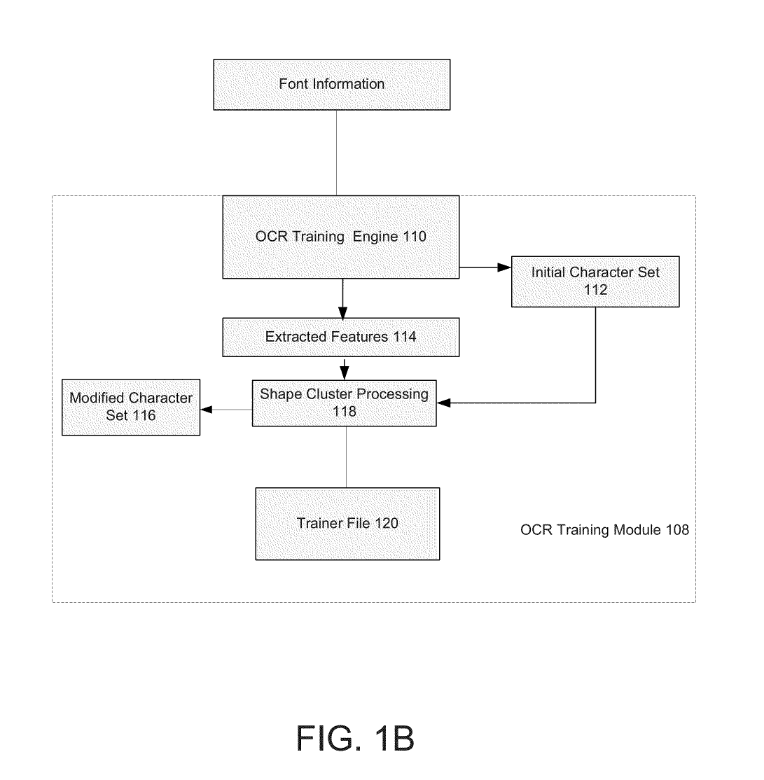

FIG. 1A is a block diagram showing an example an OCR-based system 100 that may be used to perform processes and functions disclosed herein. The OCR system 100 includes an OCR engine 102 comprising an OCR software module that processes the digital images of a document 104 and produces an OCR output 106. The OCR system 100 further includes a OCR training module 108, which comprises a software module that is applied to the initial OCR engine itself and further receives the OCR output document 106 as an input to generate a modified character set and trained data output.

FIG. 1B shows one embodiment of the OCR training module 108, which includes an OCR training engine 110, which outputs an initial character set, an extracted features module 114, shape cluster processing module 118 that produces a modified character set 116, and a trainer file 120, which comprises trained data. The modified character set produced by the shape cluster module 118 is output to a language processing module 124 which is then used to output a modified OCR output document 126. In addition, the modified character set is output to the trainer file that is used in subsequent OCR documents and can improve the accuracy of character detection in the subsequent OCR output documents.

A typical OCR engine generally produces rectangular bounding boxes intended to enclose collectively the text written on each page. Generally, when the document image has grayscale or color information, the OCR engine binarizes the image so that each image pixel is determined to be either a foreground pixel (e.g., black text) or a background pixel (e.g., a white region). Each bounding box normally encloses one or more connected groups of text pixels of one character perceived by the OCR engine. The OCR engine generally assigns one or more shape classifications to each bounding box. Each shape classification identifies one or more characters that the engine has recognized in the bounding box. If the OCR engine fails to recognize any character in a bounding box, it may assign no shape classifications to the bounding box. Each character identified by one of shape classifications can be represented in a standard character encoding, for example an ASCII or Unicode encoding.

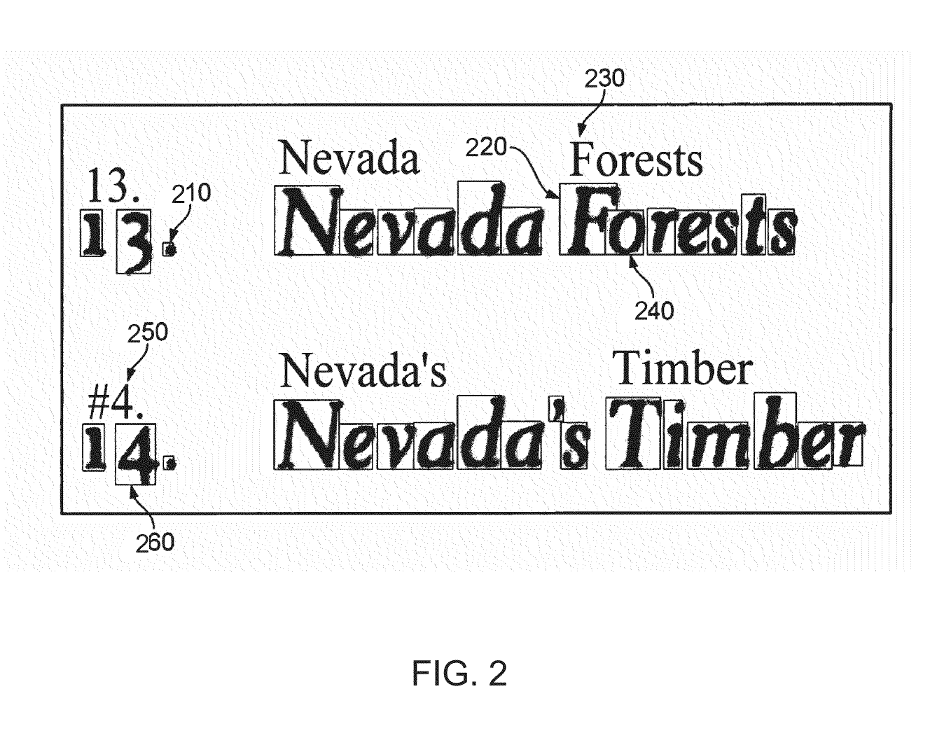

FIG. 2 illustrates an example of bounding boxes, and associated enclosed text generated by the typical OCR engine. As shown, the OCR engine processes the original digital image of the document and segments the original image into separated character shapes which may correspond to separated recognized characters. The OCR engine produces and uses a bounding box to enclose and to identify one or more separately recognized characters. For example, bounding boxes 210, 220, 240 and 260 in FIG. 2 enclose the punctuation mark period, the letter “F,” the letter “o,” and the number “4,” respectively.

In one example, character shapes which may be recognized by the OCR engine may include clip images segmented from the digital image. In other examples, the OCR engine may process other graphical representations or shape features of the character shapes, including outline polygons, or a collection of edges from the character image, which may be referred to as a recognizable unit.

The OCR engine then assigns a shape classification for each bounding box which can represent one or more characters. Each character can include one or more language tokens, where a language token (or grapheme) is a fundamental unit of a language and can include, for example, a letter, a numeral, and a symbol or mark. In one example, a glyph is an individual mark that contributes to the meaning of what is written. A symbol or mark can be, for example, a punctuation mark, a typographical mark or a diacritical mark. Hence, examples of a character can be a letter, a numeral, a symbol or mark, and a ligature of two or more language tokens (e.g. comprising two of more letters joined together). The shape classification can include multiple grapheme/character sequences, which have been merged into a single shape by the clustering process during training, as further described below.

FIG. 2 shows one example of OCR characters generated from corresponding assigned shape classifications for letters, numbers and punctuation marks typically generated by an OCR engine. The text characters 230 and 250 are generated from shape classifications assigned by the OCR engine to the portion of the document image contained within the bounding box 220 for letter “F” and the bounding box 260 for number “4,” respectively. In the example illustrated in FIG. 2, the OCR engine generated bounding boxes that are rectangular and which vary in their sizes and aspect ratios in accordance with the sizes and aspect ratios of the enclosed separated characters. In this example, each bounding box encloses the image pixels of one character.

Original digital images of a document are first processed by the OCR engine to produce the OCR output document that includes separated bounding boxes surrounding clip images within the original digital images. The OCR engine also assigns shape classifications to the bounding boxes, respectively. The OCR training module further described below extracts a “character set” (or “unicharset”) from the OCR output document and further applies shape clustering techniques to extract additional shape or feature information based on pattern similarity (or dissimilarity) of the characters. According to one embodiment, shape or feature information is further used to improve or enhance character detection accuracy. The trained character set is used to modify the OCR output document and may be further used for any subsequent OCR document processing of additional imaged documents. In addition, as further described below, the trained character set may be also used for language processing.

The shape cluster processing module 118 uses methods of shape clustering that use character shape information to generate a modified character set. The process of shape clustering includes first classifying the clip images defined by bounding boxes in the OCR output into different clusters of clip images. The clip images classified in one cluster have been assigned a shape classification, which may include multiple grapheme/characters recognized as identical or similar sizes by the OCR engine and are determined by the post-OCR processing to have identical or similar shapes based on a suitable shape metric such as a shape distance. As an example, such a cluster can include identical or similar clip images for a letter “C” at or near a particular clip image size. Hence, the above classification process uses the suitable shape metric to compare shapes of different clip images assigned to the shape classification and of identical or similar sizes.

A cluster image can be generated to represent the clip images in each cluster. The cluster image can be a representative image of the clip images of each cluster and can be generated with different methods. In another example, one of the clip images in a cluster can be selected as the cluster image. After a cluster image is generated for each cluster, each cluster can be represented in various post-OCR processing operations by the cluster image and the one or more shape classifications assigned to the cluster.

In one example, after the clusters are formed, subsequent error detection methods can be conducted at the cluster level. According to some examples of error detection, each cluster image is compared with other cluster images based on shape similarity to verify assignment of the shape classification to a cluster and detect erroneously assigned shape classification to a cluster in the OCR output. If no error is detected in comparing different cluster images, the shape classifications assigned to a cluster are verified to be correct. If an error is detected, one or more new shape classifications can be generated and assigned to the cluster.

In one example, after the one or more new shape classifications are generated, the one or more new shape classifications are used to replace the erroneously assigned shape classifications at each occurrence of the clip images of the cluster in the OCR output to produce a modified OCR output. This correction of the OCR error is performed at the cluster level and is applied to all images in that cluster. This cluster-level processing can be more efficient than techniques that perform error correction one image instance or appearance in the original document at a time. For at least this reason, this cluster-level processing can be advantageous in efficiently processing voluminous documents, which is common in OCR processing.

The OCR methods described above result in fairly accurate detection of Latin-based languages and scripts, but results in low OCR accuracy for complex scripts. The methods of radical analysis described below improve OCR accuracy on complex scripts, such as Traditional Chinese, Japanese, and Southern Indic languages such as Tamil, Telugu, Kannada, Malayalam and Thai.

It is appreciated that in these complex scripts, the number of symbols to be distinguished is very high, and there are many inherently similar character shapes. According to various embodiments described herein, the methods of radical analysis in combination with hierarchical agglomerative clustering comprising a canonical cloud distance metric can be included in the OCR training module 108 to increase accuracy of OCR detection of complex languages.

The complex languages include a fairly small set of basic shapes or glyphs, which are combined together to make more complex characters or graphemes. In one example, a grapheme includes the smallest semantically distinguishing unit in a written language and can comprise a set of different glyphs. The compound graphemes of multiple non-connected glyphs can be hard to classify into the correct cluster because they are often detected as joint clip images. The joint clip images can be assigned a number of characters codes, while one character code should be assigned resulting in low accuracy. In various embodiments described herein, the radical analysis recognizes the individual glyphs included in the compound grapheme separately and then determines the compound grapheme character from the combination of the parts or glyphs.

In various embodiments, the methods of radical analysis in combination with hierarchical agglomerative clustering comprising a canonical cloud distance metric, described below, also have the purpose of merging severely ambiguous character clusters, with the goal of reducing accuracy errors associated with these characters. In one example, an upper case Helvetica I (e.g.“I”) clip image and the clip image for the lower case “1” (e.g. “I”) may be grouped into one cluster and assigned the same character code and therefore considered ambiguous. Other ambiguous characters may include other clip images as the lower case Times New Roman letter “1” clip image and the numeral “1” in Times New Roman.

Radical Analysis

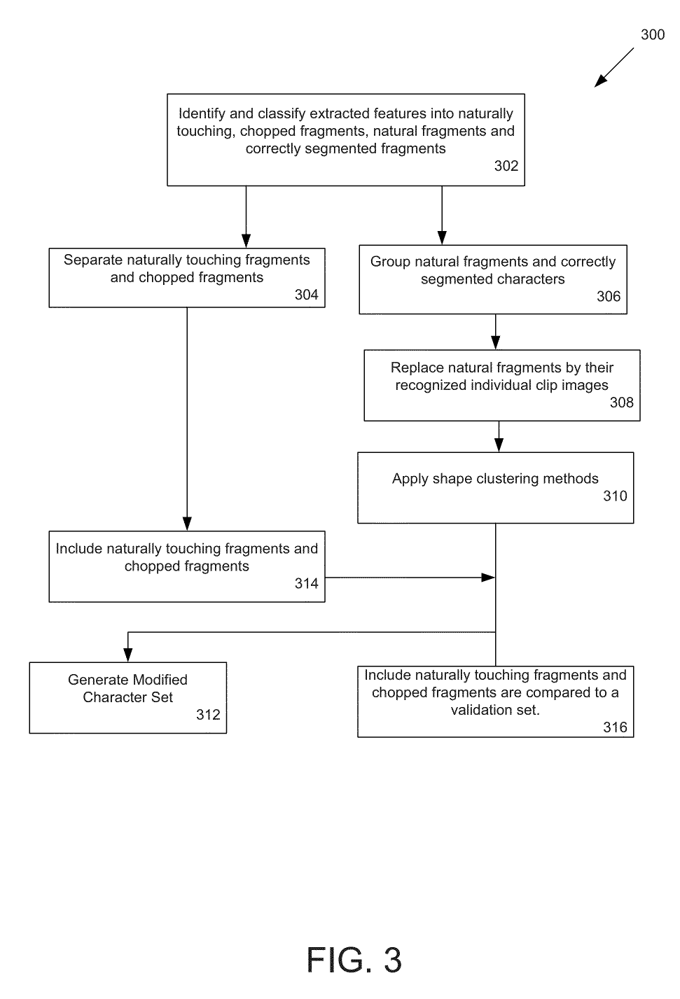

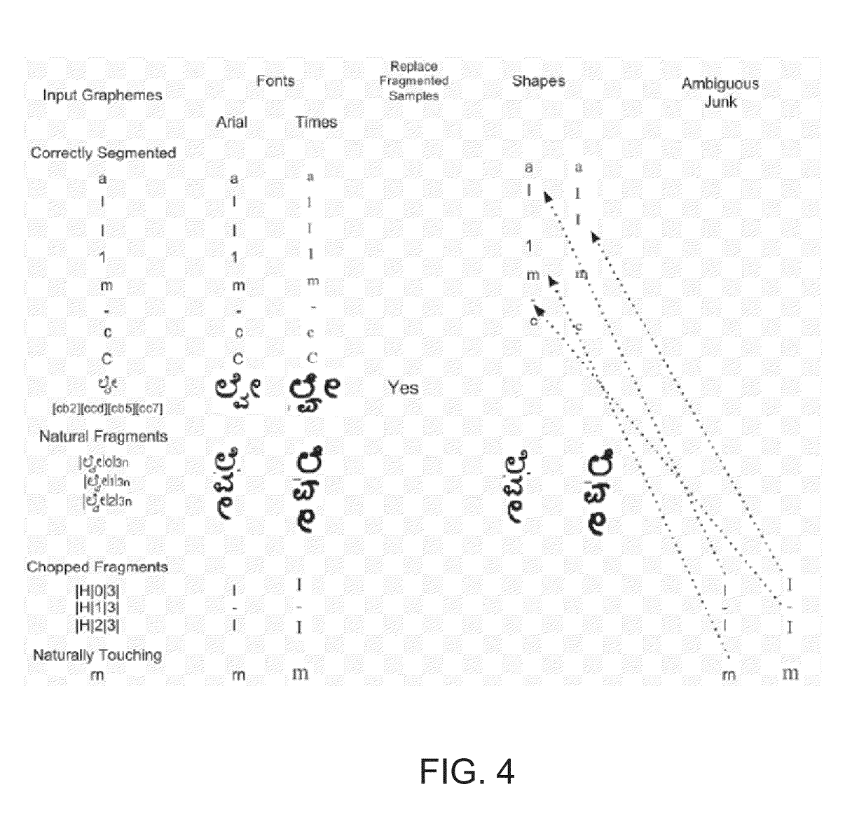

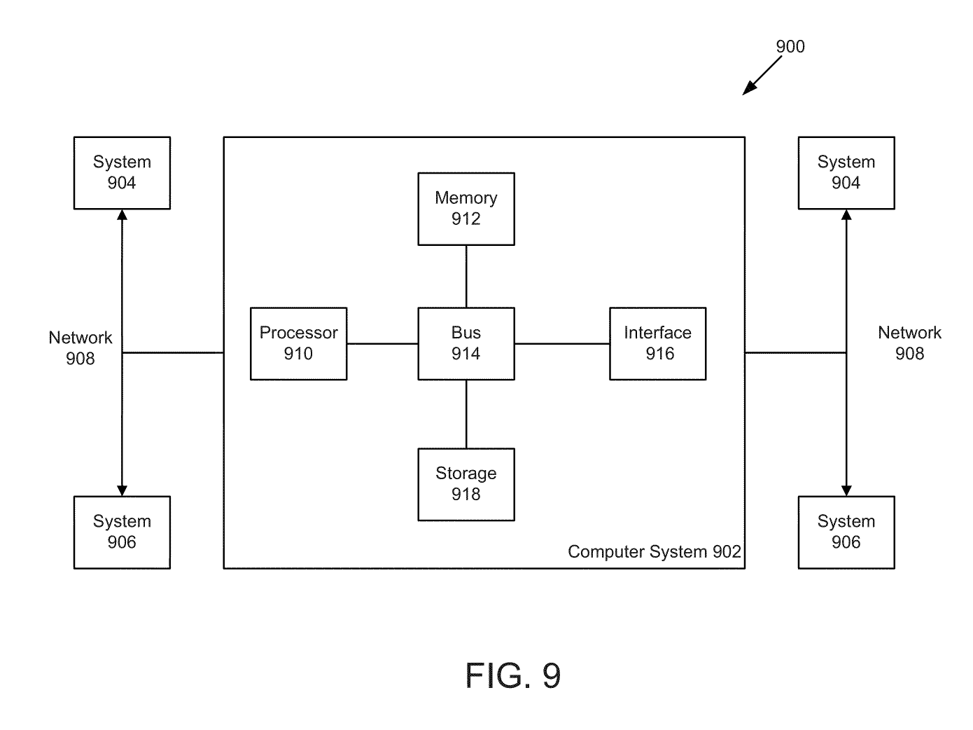

FIG. 3 shows one example of a process of radical analysis 300 using the computer systems described below with reference to FIG. 9. According to one embodiment, the extracted feature module 114 recognizes and classifies the fragments as natural fragments, chopped fragments, naturally touching fragments and correctly segmented fragments (step 302). In some examples, natural fragments include separate and connected components and are distinguishable from chopped fragments. Chopped fragments, according to various examples, include severely ambiguous characters described above. FIG. 4 shows examples of classified character fragments. As shown, one example of compound grapheme of multiple non-connected glyphs includes [symbol] which can be recognized and classified to include natural fragments of

[symbol]

One example of naturally touching characters, which can be classified into naturally touching fragments, includes characters “r” and “n.” In this example, a “r” cluster assigned the character code for the character ‘r’ includes the clip image samples for the character “r.” Some of these clip image samples in the “r” cluster may include joint clip image of a “r” clip image next to a “n” clip image, which may also be included in a two-character cluster assigned the OCR character of “rn” as part of clip images for “rn.” The cluster image for the “rn” cluster can be closer in shape to the “m” cluster than many other clusters, including the “r” and “n” clusters, which can result in false detection.

Referring again to FIG. 3, in step 304, the extracted feature module 114 separates the naturally touching fragments and the chopped fragments. In one example, the naturally touching fragments and chopped fragments can be grouped and classified as “junk.” In other examples, the naturally touching fragments and chopped fragments can be saved for further processing. The naturally fragmented graphemes and correctly segmented characters are grouped and further processed as described below (step 306). The naturally touching fragments and the chopped fragments can be classified as “junk” and can also be used by a classifier error detection process described above as examples of incorrectly identified clip images.

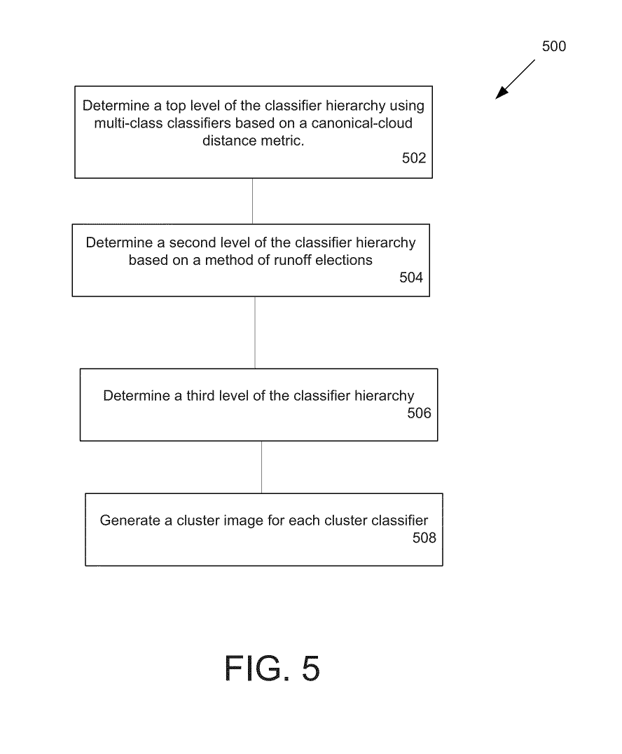

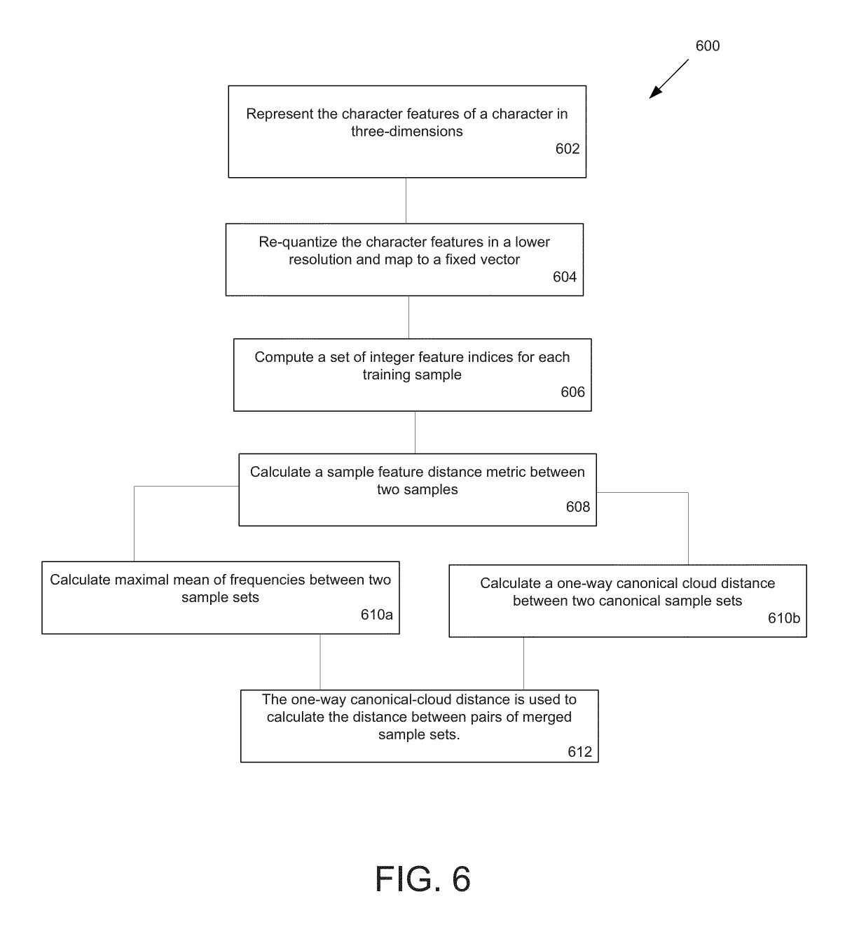

In one example, the naturally fragmented graphemes are deleted and replaced by their recognized individual clip images or component parts (step 308). This breaks up fragmented complex graphemes into clip images representing component parts of the grapheme, enabling them to be matched to similar clip images in the shape clustering processes. In step 310, a process of shape clustering 500 method is performed that includes a process of a hierarchical agglomerative clustering between groups of samples from a single font, further described below with reference to FIG. 5. The hierarchical agglomerative clustering is determined based on a distance metric which is further described below with reference to FIG. 6.

In step 312, the shape clustering process 500 generates a modified character set. The modified character set is output to the language processing module 124. The language processing module 124 may comprise a directed acyclic word graph (DAWG) process. The language processing module may include wordlists and may process the OCR output document by comparing a particular word from the output document, one letter at a time, against the wordlist to correct any character errors from the OCR engine.

In step 314, the extracted feature module 114 adds the previously removed naturally touching and chopped clip images to the output of the shape clustering process 500. In some examples, those clip images that are close matches to existing character shapes included in a validation set of character shapes are added to the existing character shapes, and those clip images that do not match are labeled as “junk” (step 316). This step of separating non-matching characters from the matching characters can enable the identification of ambiguous characters as “junk” without overhead of extra classification time.

The resulting modified character set may be output to the master trainer file 120. The trainer file can be used to further modify the OCR output document 106 to produce the modified OCR output document 126 based on the determined character set. The trainer file can also be used to process any imaged document subsequently input to the OCR engine 102, which results in a higher accuracy character detection.

Hierarchical Agglomerative Clustering

FIG. 5 shows one example of a process of shape clustering 500 using the computer systems described below with reference to FIG. 9. Using the shape clustering process 500, the cluster processing module 118 divides clip images into a hierarchy of classes where clip images in one class are assigned one or more common shape classifications. In one embodiment, the clip images in one cluster have identical or similar shapes based on their shape distances from one another. The shape distances are determined using features indices further described below with reference to FIG. 6.

As noted above, the cluster processing module 118 uses the hierarchical agglomerative clustering process to divide clip images into a hierarchy of classes and to assign shape classifications to those classes. In summary, the hierarchy of classes may be determined based on distances that are computed between each pair of clip images, and the closest two clip images may be merged until the minimum remaining distance exceeds a threshold.

Typical OCR engines use either a one-shot multi-class classifier or a binary tree classifier. The one-shot multi class classifier classifies a character as a single member of the alphabet in a single step resulting in a homogeneous classifier. Alternatively, the binary tree classifier which makes two-way decisions from a single feature space repeatedly until it arrives at a single character result. Instead, according to some examples, the hierarchical agglomerative clustering process 500 described herein builds a hierarchy of classifiers, and applies a different classifier process at each level of the hierarchy to optimize the result. In these examples, the hierarchical classifier is non-binary and heterogeneous.

In step 502, in one example, a top or first level of the hierarchy is determined by shape clustering. The cluster processing module 118 may first divide clip images into classes to which a classifier may be assigned, and in each class, may divide clip images into buckets. In each bucket, the cluster processing module 118 may divide clip images into clusters where clip images in one cluster have identical or similar shapes based on their shape distances from one another. In one example, different predetermined distance metrics determine different buckets and classes and thus different levels of the hierarchy. A determination of the distance metric according to one embodiment is described further below. At this top level, a multi-class classifier can identify the character as being from one of the predetermined classifiers of similar characters. In some examples, one or two classifiers may be used within the top level.

In some examples, hierarchical agglomerative clustering is bottom-up (agglomerative), meaning that the lowest levels of the shape tree are computed first, by clustering, then the next level up and so-on. The classifiers can then trained top-down. It is appreciated however, that the top-down or bottom-up for training the classifiers is a matter of data-structure convenience and other order or operations can be implemented.

In examples involving complex scripts, there may be multiple levels of classifiers within the top level; for example two to four classifiers may be used at this level. In examples including relatively simple languages like English, a single level of classifiers may be used. For example, in the single level of classifiers, the output may group characters like I/l/1, o/O/0, and ]/j/J together in separate groups.

In step 504, a second level of classifiers may be determined. In one example, this second level includes two-class classifiers that may be trained specifically to separate a pair of character shapes and further used to determine a specific top choice character shape or cluster image, for character fragments grouped together. As discussed above with reference to process 300, the process of radical analysis grouped some character shapes or fragments together, such as chopped fragments and naturally touching fragments. In one example, the separation of joined groups of fragments may be accomplished by running all pair-wise classifications and tabulating the results in a manner similar to a process of runoff elections.

In at least one example of the runoff election process, a series of comparisons between pairs of shapes is performed to determine the closest classifier to the character between each pair of shapes. The closest shapes based on a distance metric (e.g. the “winners”) are merged together and move on to the next round. In this example, the closest shapes from the previous round of comparisons are compared to other in subsequent rounds until a minimum remaining distance between two pairs exceeds a threshold.

In step 506, a third level of classifiers may be determined, which may determine the closest matching font for a character. In one example, the third classifier may include a multi-class classifier using a set of features similar to the multi-class classifier described with reference to step 502, but may include a different set of features. In another example, the third classifier may include a two-class classifier defined a similar process of runoff elections. However other methods of determining third level of classifiers to determine matching font for the character may be used.

In step 508, in response to the classification of the clip images into clusters, the cluster processing module 118 generates a cluster image for each cluster that represents the shape of the cluster. The cluster images are output as the modified character set 116 to the language processing module 124 and to the trainer file 120 described above.

Distance Metric

FIG. 6 shows one example of a process of calculating the distance metric 600 using the computer systems described below with reference to FIG. 9. According to some examples, the maximal mean of frequencies can be used as a distance metric. According to other examples, the distance metric between two sets of samples, s1 and s2, can be defined in such a way as to be symmetric by summing a one-way distance calculated both ways. According to the examples described below, the one-way distance comprises a canonical-cloud distance, and can be designed to be generalizing. The one-way canonical-cloud distance uses the three-dimensional classification of character features further described below.

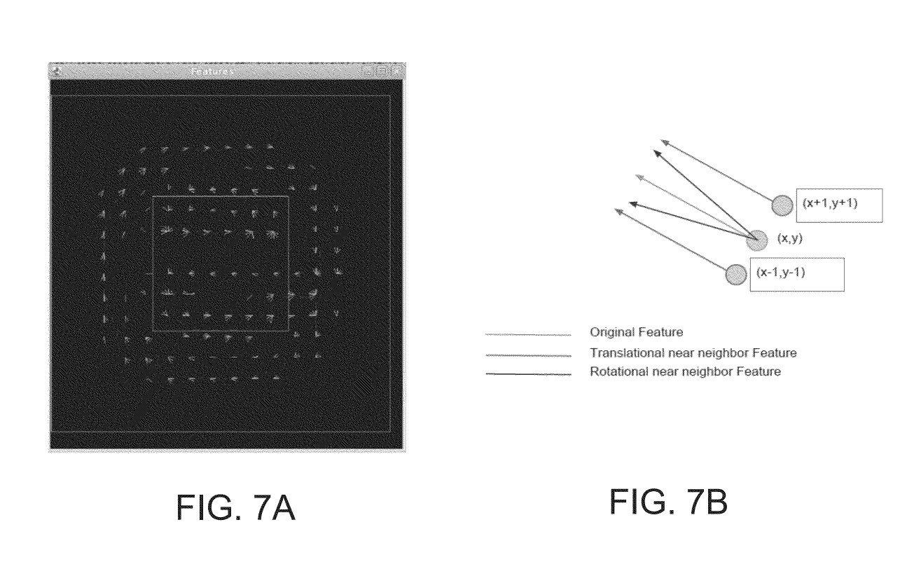

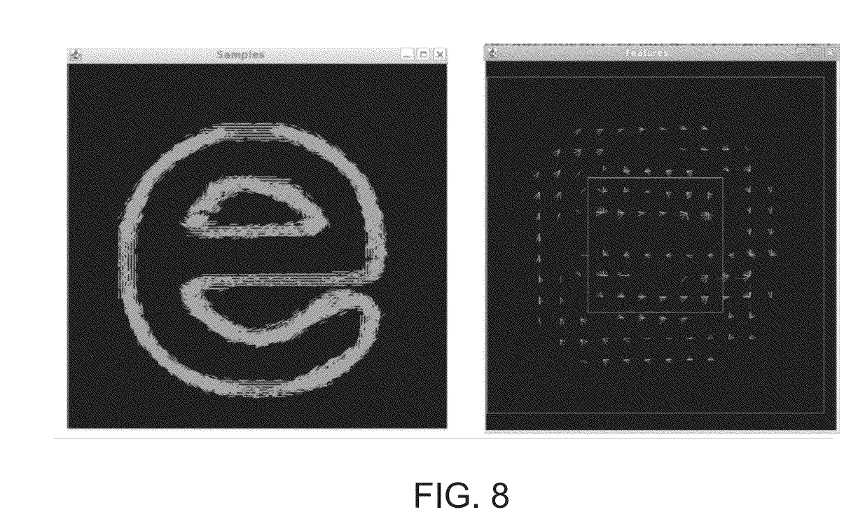

In step 602, the distance metric may be determined by first representing the character features in three-dimensions. Character features of a character are shown in FIG. 7A and include short segments of a character, each having a position and direction. The character features (F) may be defined as follows:

F={fᵢ=(xᵢ,yᵢ,θᵢ)}

with short segments of the outline of a character coded in three-dimensions: x, y position and direction, and each quantized to a resolution of [0, 255], with 0 covering the full −π to π range of directions with the convention that the inside of the character (usually black) is on the left. In one example, for typical Latin characters, the number of features for a single character (e.g. a sample) is typically between approximately 20 and 100. For complex scripts, the number of features can exceed approximately 150.

In step 604, for performing the processes of shape clustering, according to one example, the features can be re-quantized to a lower resolution and mapped to a fixed vector. One example of a lower resolution includes [0, 15] from the original resolution of [0, 255]. In one example, the fixed vector may include a 4096 dimension binary feature vector, where a 1 indicates the presence of a feature in the relevant cell in the re-quantized space. In step 606, the fixed vector may be a sparse vector, and the features for each training sample can be manipulated as a set of integer feature indices Q={qᵢ ε[0,4095]} into the binary feature space. The feature space can be re-quantized to any level of quantization desired. In the embodiments described herein, although Qi represents the indexed features of sample “i” the following text will refer to Qi as a “sample” instead of “the indexed features of sample.”

According to an embodiment, the feature space is based on an original geometric representation, where a sample “i” includes one or more near neighbors (“j”) shown in FIG. 7B. In step 608, the near neighbors of a given feature sample are computed in terms of both position and direction. The near neighbors (N) of a feature index (Qi) can be represented as follows:

N(qᵢ)={qⱼ:|xⱼ−xᵢ|<dx,|yⱼ−yᵢ|<dy,|θⱼ−θᵢ|<dθ}

where xᵢ, yᵢ, θᵢ are the components qᵢ of and likewise for qⱼ. In one example, the near neighbors are computed using a look-up table.

In step 610a, the frequency of every feature index (Qi) used by the samples is computed. A set of samples of a single character/font pair S_{c,f}={Qᵢ} is the set of sets of feature indices generated from the training samples of character (grapheme) c and font f. The canonical sample S_{c,f} from the set of samples of each character/font pair is defined to be the single sample with the maximal mean of frequencies of the features in a feature index.

Alternatively, in one embodiment, instead of the maximal mean of frequencies, a canonical-cloud distance is calculated. In step 610b, a sample feature distance metric dₛ(Qᵢ,Qⱼ) can be calculated between two samples by counting the number of (quantized) feature indices that do not occur in both samples, and dividing by the total number of features. In some examples, there is enough natural variation in the features to make this measure somewhat unreliable, so it is improved by actually allowing near misses by considering the near neighbors as well with a weighted count.

The canonical sample S_{c,f} from the set of samples of each character/font pair is defined to be the sample with the least maximum sample feature distance to all other samples of the same character/font pair. In some examples, an average sample from that set ( Q̅_{c,f}) can be expressed by the following:

Q_{c,f}=arg min_{QiεSc,f}max_{QjεSc,f}[dₛ(Qᵢ,Qⱼ)]

The cloud features of a set of samples of each character/font pair is the union of all feature indices used by all samples (after outlier removal) of that character/font pair. One example of the cloud features of a set of samples (C_{c,f}) are shown in FIG. 8 and can be expressed by:

$${C}_{c , f} = {⋃}_{{Q}_{i} ∈ {S}_{c , j}} {Q}_{i}$$

The one-way canonical-cloud distance between two sample sets S_{c1,f1} and S_{c}_{₂}_{,f}_{₂} can be calculated. The one-way canonical-cloud distance counts one for each feature in the canonical sample of set that is not in the cloud features of S_{c}_{₂}_{,f}_{₂} and nor are any of the feature's near neighbors. The one-way canonical-cloud distance (d_{CC}(S_{c1,f1},S_{c2,f2})) can be expressed as:

d_{CC}(S_{c1,f1},S_{c2,f2})=|{qᵢε Q̅_{c1,f1}:{qᵢε Q̅_{c1,f2}:qᵢεC_{c2,f2},N(qᵢ)∩C_{c2,f2}=\textcircled{×}]|

It follows that the symmetric distance used in shape clustering may be thus made up from the one-way canonical-cloud distance, which defines a distance between a pair of single character/font sample sets. The one-way canonical-cloud distance is used to calculate the distance between pairs of merged sample sets. The distance between pairs of merged sample sets is the mean of the pair-wise sample-set distances between all pairs of single character/font sample sets that can be formed between the two sets. To avoid a squared-order explosion, this is optimized in the case of large sample sets by using a pseudo-random sub-sampling that uses the larger set once, and re-uses members of the smaller set.

Example Computer Implementations

Various aspects and functions described herein, in accord with aspects of the present invention, may be implemented as hardware, software, or a combination of hardware and software on one or more computer systems. There are many examples of computer systems currently in use. Some examples include, among others, network appliances, personal computers, workstations, mainframes, networked clients, servers, media servers, application servers, database servers, web servers, and virtual servers. Other examples of computer systems may include mobile computing devices, such as cellular phones and personal digital assistants, and network equipment, such as load balancers, routers and switches. Additionally, aspects in accord with the present invention may be located on a single computer system or may be distributed among one or more computer systems connected to one or more communication networks.

For example, various aspects and functions may be distributed among one or more computer systems configured to provide a service to one or more client computers, or to perform an overall task as part of a distributed system. Additionally, aspects may be performed on a client-server or multi-tier system that includes components distributed among one or more server systems that perform various functions. Thus, the invention is not limited to executing on any particular system or group of systems. Further, aspects may be implemented in software, hardware or firmware, or any combination thereof. Thus, aspects in accord with the present invention may be implemented within methods, acts, systems, system placements and components using a variety of hardware and software configurations, and the implementation is not limited to any particular distributed architecture, network, or communication protocol. Furthermore, aspects in accord with the present invention may be implemented as specially-programmed hardware and/or software.

FIG. 9 shows a block diagram of a distributed computer system 900, in which various aspects and functions in accord with the present invention may be practiced. The distributed computer system 900 may include one more computer systems. For example, as illustrated, the distributed computer system 900 includes three computer systems 902, 904 and 906. As shown, the computer systems 902, 904 and 906 are interconnected by, and may exchange data through, a communication network 908. The network 908 may include any communication network through which computer systems may exchange data. To exchange data via the network 908, the computer systems 902, 904 and 906 and the network 908 may use various methods, protocols and standards including, among others, token ring, Ethernet, Wireless Ethernet, Bluetooth, TCP/IP, UDP, HTTP, FTP, SNMP, SMS, MMS, SS7, JSON, XML, REST, SOAP, CORBA HOP, RMI, DCOM and Web Services.

Computer systems 902, 904 and 906 may include mobile device such as cellular telephones. The communication network may further employ one or more mobile access technologies including 2nd (2G), 3rd (3G), 4th (4G or LTE) generation radio access for cellular systems, WLAN, Wireless Router (WR) mesh, and other communication technologies. Access technologies such as 2G, 3G, 4G and LTE and future access networks may enable wide area coverage for mobile devices. For example, the network may enable a radio connection through a radio network access such as Global System for Mobil communication (GSM), General Packet Radio Services (GPRS), Enhanced Data GSM Environment (EDGE), Wideband Code Division Multiple Access (WCDMA), among other communication standards. Network may include any wireless communication mechanism by which information may travel between the devices 104 and other computing devices in the network.

To ensure data transfer is secure, the computer systems 902, 904 and 906 may transmit data via the network 908 using a variety of security measures including TSL, SSL or VPN, among other security techniques. While the distributed computer system 900 illustrates three networked computer systems, the distributed computer system 900 may include any number of computer systems, networked using any medium and communication protocol.

Various aspects and functions in accord with the present invention may be implemented as specialized hardware or software executing in one or more computer systems including the computer system 902 shown in FIG. 9. As depicted, the computer system 902 includes a processor 910, a memory 912, a bus 914, an interface 916 and a storage system 918. The processor 910, which may include one or more microprocessors or other types of controllers, can perform a series of instructions that manipulate data. The processor 910 may be a well-known, commercially available processor such as an Intel Pentium, Intel Atom, ARM Processor, Motorola PowerPC, SGI MIPS, Sun UltraSPARC, or Hewlett-Packard PA-RISC processor, or may be any other type of processor or controller as many other processors and controllers are available. As shown, the processor 910 is connected to other system placements, including a memory 912, by the bus 914.

The memory 912 may be used for storing programs and data during operation of the computer system 902. Thus, the memory 912 may be a relatively high performance, volatile, random access memory such as a dynamic random access memory (DRAM) or static memory (SRAM). However, the memory 912 may include any device for storing data, such as a disk drive or other non-volatile storage device, such as flash memory or phase-change memory (PCM). Various embodiments in accord with the present invention can organize the memory 912 into particularized and, in some cases, unique structures to perform the aspects and functions disclosed herein.

Components of the computer system 902 may be coupled by an interconnection element such as the bus 914. The bus 914 may include one or more physical busses (for example, busses between components that are integrated within a same machine), and may include any communication coupling between system placements including specialized or standard computing bus technologies such as IDE, SCSI, PCI and InfiniBand. Thus, the bus 914 enables communications (for example, data and instructions) to be exchanged between system components of the computer system 902.

Computer system 902 also includes one or more interface devices 916 such as input devices, output devices and combination input/output devices. The interface devices 916 may receive input, provide output, or both. For example, output devices may render information for external presentation. Input devices may accept information from external sources. Examples of interface devices include, among others, keyboards, mouse devices, trackballs, microphones, touch screens, printing devices, display screens, speakers, network interface cards, etc. The interface devices 916 allow the computer system 902 to exchange information and communicate with external entities, such as users and other systems.

Storage system 918 may include a computer-readable and computer-writeable nonvolatile storage medium in which instructions are stored that define a program to be executed by the processor. The storage system 918 also may include information that is recorded, on or in, the medium, and this information may be processed by the program. More specifically, the information may be stored in one or more data structures specifically configured to conserve storage space or increase data exchange performance. The instructions may be persistently stored as encoded signals, and the instructions may cause a processor to perform any of the functions described herein. A medium that can be used with various embodiments may include, for example, optical disk, magnetic disk or flash memory, among others. In operation, the processor 910 or some other controller may cause data to be read from the nonvolatile recording medium into another memory, such as the memory 912, that allows for faster access to the information by the processor 910 than does the storage medium included in the storage system 918. The memory may be located in the storage system 918 or in the memory 912. The processor 910 may manipulate the data within the memory 912, and then copy the data to the medium associated with the storage system 918 after processing is completed. A variety of components may manage data movement between the medium and the memory 912, and the invention is not limited thereto.

Further, the invention is not limited to a particular memory system or storage system. Although the computer system 902 is shown by way of example as one type of computer system upon which various aspects and functions in accord with the present invention may be practiced, aspects of the invention are not limited to being implemented on the computer system, shown in FIG. 9. Various aspects and functions in accord with the present invention may be practiced on one or more computers having different architectures or components than that shown in FIG. 9. For instance, the computer system 902 may include specially-programmed, special-purpose hardware, such as for example, an application-specific integrated circuit (ASIC) tailored to perform a particular operation disclosed herein. Another embodiment may perform the same function using several general-purpose computing devices running MAC OS System X with Motorola PowerPC processors and several specialized computing devices running proprietary hardware and operating systems.

The computer system 902 may include an operating system that manages at least a portion of the hardware placements included in computer system 902. A processor or controller, such as processor 910, may execute an operating system which may be, among others, a Windows-based operating system (for example, Windows NT, Windows 1000/ME, Windows XP, Windows 7, or Windows Vista) available from the Microsoft Corporation, a MAC OS System X operating system available from Apple Computer, one of many Linux-based operating system distributions (for example, the Enterprise Linux operating system available from Red Hat Inc.), a Solaris operating system available from Sun Microsystems, or a UNIX operating systems available from various sources. Many other operating systems may be used, and embodiments are not limited to any particular operating system.

The processor and operating system together define a computing platform for which application programs in high-level programming languages may be written. These component applications may be executable, intermediate (for example, C# or JAVA bytecode) or interpreted code which communicate over a communication network (for example, the Internet) using a communication protocol (for example, TCP/IP). Similarly, functions in accord with aspects of the present invention may be implemented using an object-oriented programming language, such as SmallTalk, JAVA, C++, Ada, or C# (C-Sharp). Other object-oriented programming languages may also be used. Alternatively, procedural, scripting, or logical programming languages may be used.

Additionally, various functions in accord with aspects of the present invention may be implemented in a non-programmed environment (for example, documents created in HTML, XML or other format that, when viewed in a window of a browser program, render aspects of a graphical-user interface or perform other functions). Further, various embodiments in accord with aspects of the present invention may be implemented as programmed or non-programmed placements, or any combination thereof. For example, a web page may be implemented using HTML while a data object called from within the web page may be written in C++. Thus, the invention is not limited to a specific programming language and any suitable programming language could also be used.

It is to be appreciated that embodiments of the methods and apparatuses discussed herein are not limited in application to the details of construction and the arrangement of components set forth in the following description or illustrated in the accompanying drawings. The methods and apparatuses are capable of implementation in other embodiments and of being practiced or of being carried out in various ways. Examples of specific implementations are provided herein for illustrative purposes only and are not intended to be limiting. In particular, acts, elements and features discussed in connection with any one or more embodiments are not intended to be excluded from a similar role in any other embodiments.

Also, the phraseology and terminology used herein is for the purpose of description and should not be regarded as limiting. Any references to embodiments or elements or acts of the systems and methods herein referred to in the singular may also embrace embodiments including a plurality of these elements, and any references in plural to any embodiment or element or act herein may also embrace embodiments including only a single element. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Any references to front and back, left and right, top and bottom, upper and lower, and vertical and horizontal are intended for convenience of description, not to limit the present systems and methods or their components to any one positional or spatial orientation.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A computer-implemented method of processing an image of a document using an optical character recognition process, the method comprising acts of:
extracting, by a computer system, a plurality of recognizable units from the document;
extracting, by the computer system, a plurality of features from the plurality of recognizable units;
separating, by the computer system, the plurality of recognizable units, based on the plurality of extracted features into a plurality of fragments having at least one fragment type;
determining a distance metric between the plurality of recognizable units, based on the plurality of extracted features; and
classifying, by the computer system, the plurality of recognizable units into a plurality of clusters based on the distance metric, each cluster including a set of recognizable units associated with a shape classification.

2. The method of claim 1, wherein the at least one fragment type includes at least one of naturally fragmented recognizable units, chopped fragmented recognizable units, naturally touching recognizable units, and correctly segmented recognizable units.

3. The method of claim 1, wherein the plurality of recognizable units include any of clip images, outline polygons, or character edges.

4. The method of claim 2, further including an act of replacing the naturally fragmented recognizable units with individual recognizable units.

5. The method of claim 4, further including an act of comparing the naturally fragmented recognizable units and the correctly segmented recognizable units to the plurality of recognizable units included in a validation set of recognizable units.

6. The method of claim 4, wherein the act of assigning the plurality of recognizable units the at least one hierarchical classifier further includes an act of dividing the plurality of recognizable units into a hierarchy of classes, wherein the recognizable units in each class are assigned a different classifier.

7. The method of claim 6, wherein the act of dividing the plurality of recognizable units into the hierarchy of classes further includes an act of determine at least one hierarchical class using a multi-class classifier.

8. The method of claim 6, wherein the act of dividing the plurality of recognizable units into the hierarchy of classes further determining at least one hierarchical class using runoff elections.

9. The method of claim 8, further including:
merging pairs of recognizable units separated by a defined shape metric distance until the defined shape metric distance exceed a minimum threshold.

10. The method of claim 2, further including an act of separating at least one of the naturally touching recognizable units and the chopped fragmented recognizable units.

11. A system of processing an image of a document using an optical character recognition process, the system comprising:
a non-transitory computer storage medium; and
a processor coupled to the non-transitory computer storage medium, the processor configured to:
extract a plurality of recognizable units from the document;
extract a plurality of features from the plurality of recognizable units;
determine a distance metric between the plurality of recognizable units;
classify the plurality of recognizable units into a plurality of clusters based on the distance metric, each cluster including a set of recognizable units associated with a shape classification; and
store any of the plurality of recognizable units, the plurality of clusters, the distance metric and the shape classification.

12. The system of claim 11, wherein the processor is further configured to separate the plurality of recognizable units, using the plurality of extracted features into a plurality of fragments including at least one of: naturally fragmented recognizable units, chopped fragmented recognizable units, naturally touching recognizable units, and correctly segmented recognizable units.

13. The system of claim 12, wherein the processor is further configured to replace the naturally fragmented recognizable units with individual recognizable units and the cluster processing module is configured to analyze the plurality of recognizable units using hierarchical agglomerative clustering.

14. The system of claim 13, wherein the processor is further configured to compare the naturally fragmented recognizable units and the correctly segmented recognizable units to the plurality of recognizable units included in a validation set of recognizable units.

15. The system of claim 14, wherein the processor is further configured to divide the plurality of recognizable units into a hierarchy of classes, wherein recognizable units in each class are assigned a different classifier.

16. The system of claim 15, wherein the processor is further configured to determine at least one hierarchical class using a multi-class classifier.

17. The system of claim 15, wherein the processor is further configured to determine at least one hierarchical class using runoff elections.

18. The system of claim 12, wherein the processor is further configured to separate at least one of the naturally touching recognizable units and the chopped fragmented recognizable units.

19. The system of claim 11, wherein the plurality of recognizable units include any of clip images, outline polygons, or character edges.

20. A computer readable medium having stored thereon sequences of instruction for processing an image of a document using an optical character recognition process, including instructions that will cause a processor to:
extract a plurality of recognizable units from the document;
extract a plurality of features from the plurality of recognizable units;
determine a distance metric between the plurality of recognizable units;
classify the plurality of recognizable units into a plurality of clusters based on the distance metric, each cluster including a set of recognizable units associated with a shape classification; and
store any of the plurality of recognizable units, the plurality of clusters, the distance metric and the shape classification.
